(19) United States
(12) Patent Application Publication
(10) Pub. No.: US 2020/0388820 A1
(43) Pub. Date: Dec. 10, 2020

(54) CURRENT COLLECTOR AND CURRENT COLLECTOR-ELECTRODE ASSEMBLY FOR AN ACCUMULATOR OPERATING ACCORDING TO THE PRINCIPLE OF ION INSERTION AND DEINSERTION

(71) Applicant: COMMISSARIAT À L'ÉNERGIE ATOMIQUE ET AUX ÉNERGIES AL TERNATIVES, Paris (FR)

(72) Inventors: Thibaut Gutel, Veurey-Voroize (FR); Willy Porcher, Seyssins (FR)

(21) Appl. No.: 16/769,492

(22) PCT Filed: Dec. 7, 2018
(86) PCT No.: PCT/FR2018/053159

§ 371 Date: Jun. 3, 2020

(30) Foreign Application Priority Data
Dec. 8, 2017 (FR) 1761871

(51) Int. Cl. H01M 4/04; H01M 4/62; H01M 4/66; H01M 4/38

(52) U.S. Cl. CPC H01M 4/0404; H01M 4/623; H01M 2004/028; H01M 4/382; H01M 4/663; H01M 4/661

(57) ABSTRACT

A current collector for an accumulator with ion insertion or deinsertion, the collector being coated on at least one of the faces thereof with an inactive layer intended for providing a junction between the current collector and an electrode, the inactive layer comprising at least one organic binder and at least one salt, one of the ions of which is that which is involved in the process of ion insertion or deinsertion in the active material of the electrode.

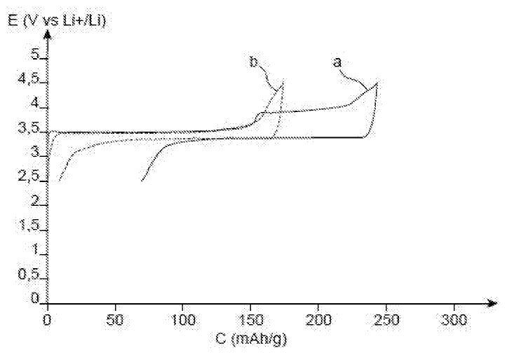

### TECHNICAL FIELD

The present invention relates to a new type of current collector and to an assembly comprising said type of current collector and an electrode intended for being used in accumulators operating according to the principle of ion insertion and deinsertion in the active material of the electrode, accumulators of said type being able to be M-ion accumulators, with M corresponding to lithium, sodium, potassium, magnesium.

The accumulators of said type are intended to be used as an autonomous source of energy, in particular, in portable electronic equipment (such as mobile phones, laptops, tools), in order to progressively replace the nickel-cadmium (NiCd) and nickel-metal hydrid (NiMH) accumulators. Same may also be used to provide the power supply necessary for new micro applications, such as smart cards, sensors or other electromechanical systems as well as for electromobility.

From the point of view of the operation thereof, the aforementioned accumulators operate according to the principle of ion insertion-deinsertion in the active materials.

By taking for example, the lithium accumulators, during the discharging of the accumulator, the negative electrode releases lithium in Li⁺ ion form, which migrates through the ionically conductive electrolyte and is incorporated into the active material of the positive electrode in order to form a material, wherein is inserted the lithium. The passage of each Li⁺ ion in the internal circuit of the accumulator is exactly offset by the passage of an electron in the external circuit, thus generating an electric current.

On the other hand, during the charging of the accumulator, the reactions occurring within the accumulator are the inverse reactions of the discharging, namely that:
the negative electrode will incorporate lithium into the network of the material constituting same; and
the positive electrode will release lithium, which will be incorporated into the material of the negative electrode in order to form an insertion material or an alloy.

During the first charge cycle of the accumulator, when the active material of the negative electrode is brought to an insertion potential of the lithium, a portion of the lithium will react with the electrolyte at the surface of the grains of active material of the negative electrode in order to form a passivation layer at the surface thereof. The formation of said passivation layer consumes a significant quantity of lithium ions, which is materialised by an irreversible loss of capacity of the accumulator (said loss being qualified as irreversible capacity and able to be assessed in the order of 5 to 20% of the initial total capacity of the system), due to the fact that the lithium ions having reacted are no longer available for the later charging/discharging cycles. Other surface reactions may also occur with consumption of lithium, as the reduction of the oxide layer located at the surface of the active material, notably when same is silicon, in order to form compounds of the Li₄SiO₄ type. What is more, a portion of the insertion reactions in the insertion materials may be irreversible, which consumes lithium, which thereafter will no longer be available.

Therefore, said losses should be minimised, as much as possible, during the first charge, so that the energy density of the accumulator is as high as possible.

In order to offset said phenomenon, it may be envisaged an additional source of lithium in the electrode material, which may also be used as a reserve of ions in order to offset the losses during the service life of the accumulator and thus improve same or to be able to work with an electrode material over a specific range of capacities, for which the loss by cycle is, for example, reduced.

To do this, it has been proposed techniques for introducing additional lithium into the negative electrode or the positive electrode in order to overcome the aforementioned drawback, said techniques able to be:
prelithiation techniques of the negative electrode; or
overlithiation of the positive electrode.

Concerning the prelithiation techniques of the negative electrode, it may be cited:
the so-called “in situ” techniques consisting in depositing onto the negative electrode lithium metal (that is to say at “0” degree of oxidation) either in the form of a metal sheet (as described in WO 1997031401) or in the form of a lithium metal powder stabilised by a protective layer (as described in Electrochemistry Communications 13 (2011) 664-667) mixed with the ink comprising the ingredients of the negative electrode (namely, the active material, the electronic conductors and an organic binder), the lithium insertion taking place, independently of the alternative retained, spontaneously by a corrosion phenomenon;
the so-called “ex situ” techniques consisting in electrochemically prelithiating the negative electrode, by placing same in a set-up including an electrolytic bath and a counter-electrode comprising lithium, said techniques make it possible to control the quantity of lithium introduced into the negative electrode but however have the drawback of requiring the implementation of a complex experimental set-up.

Alternatively, it has also been proposed, in the prior art, techniques of overlithiation of the positive electrode, notably, by adding in the composition comprising the ingredients that constitute the positive electrode, a sacrificial salt which, during the first charge, will decompose and provide the required quantity of Li in order to form the passivation layer at the surface of the negative electrode and offset the irreversible lithium consumption phenomena.

In said techniques, it should be noted that the sacrificial salt must, in principle, be able to decompose at a potential located in a potential window compatible with the electrode concerned and the electrolyte during the first charge.

Also, when the first charge takes place, two simultaneous electrochemical reactions generate Li⁺ ions, that are the deinsertion of lithium from the positive electrode and the decomposition of the sacrificial salt. During the decomposition of the sacrificial salt, it is formed notably inert, solid, liquid or gaseous by-products, which will optionally be removed at the end of the formation step. Indeed, unnecessarily increasing the burden on the accumulator by said by-products is thus prevented, which, furthermore, could disturb the later electrochemical operation of the cell.

What is more, the decomposition of the sacrificial salt within the positive electrode may result in the creation of pores within same, which thus constitute morphological defects, which may be detrimental to the performances of the accumulator, in particular, the power performances and the service life.

Also, in view of the foregoing, the authors of the present invention set themselves the goal of developing a specific collector, which once arranged in an assembly comprising said current collector and an electrode, makes it possible to prevent modification of the morphological properties of the electrode, during operation of the accumulator.

### DESCRIPTION OF THE INVENTION

Thus, the invention relates to a current collector for an accumulator with ion insertion or deinsertion coated on at least one of the faces thereof with an inactive layer intended for providing the junction between said current collector and an electrode comprising an active material, said inactive layer comprising at least one organic binder and at least one salt, whereof one of the ions is same that is involved in the process of ion insertion or deinsertion in the active material of the electrode, said salt is, advantageously, a sacrificial salt.

Conventionally, inactive layer means a layer devoid of active material and that therefore cannot fulfil the function of electrode. Conventionally, in the foregoing and in the following, active material means the material that is directly involved in the reversible reactions of ion insertion and deinsertion the electrode active materials during charging and discharging processes, in the meaning that same is suitable for inserting and deinserting ions in the network thereof, said ions able to be lithium ions, when the accumulator is a lithium-ion accumulator, sodium ions, when the accumulator is a sodium-ion accumulator, potassium ions, when the accumulator is a potassium-ion accumulator or magnesium ions, when the accumulator is a magnesium-ion accumulator.

By proposing such a collector, the authors of the invention have solved the problem of morphological modifications of the electrode by consumption of the sacrificial salt, said latter henceforth being incorporated into an inactive layer deposited on the current collector and intended for providing the junction between same and the electrode (said layer able to be qualified as intermediate layer, once that the current collector is integrated into an assembly including said collector and an electrode). Said salt makes it possible to offset the irreversible consumption of ions by decomposition of the salt by overoxidation, the decomposition of the salt contained in said layer being favoured due to the fact that same is placed as close as possible to the surface of the current collector. By way of example, in an accumulator based on the LiFePO₄/graphite system, wherein the electrode of the assembly is a positive electrode comprising LiFePO₄, the presence of a salt in the intermediate layer (in this case, a lithium salt) makes it possible to offset the irreversible consumption of lithium ions during the first cycle, thus procuring a gain of 10% of capacity during the later cycle. Said salt may also be used as a reserve of ions during the life of the accumulator or for making an electrode active material work over a specific range of capacities. What is more, the presence of said inactive layer between the current collector and the electrode makes it possible to limit the corrosion phenomena, notably of the collector, reduce the resistance of the electrode and promote the adhesion of the electrode and limit the risks of detachment of same in relation to an assembly where same would be deposited directly on the current collector.

According to the invention, the current collector includes an electrically conductive substrate, for example, a metal substrate (said metal substrate may be in the form of a metal strip), said substrate is coated on at least one of the faces thereof by said inactive layer.

By way of example, it may be a metal substrate consisting of one or more metal elements selected from copper, aluminium, nickel and the mixtures thereof.

As mentioned above, the inactive layer intended for providing the junction between the current collector and the electrode comprises at least one organic binder and at least one salt, whereof one of the ions is same that is involved in the process of ion insertion or deinsertion in the active material of the electrode, said salt is, advantageously, a sacrificial salt. Said inactive layer may have a thickness of 100 nm to 10 μm, preferably, of 1 to 2 μm.

The salt, whereof one of the ions is same that is involved in the process of ion insertion or deinsertion in the active material may be, advantageously, qualified as “sacrificial salt”. Indeed, during the first charge of the accumulator, wherein the electrode is incorporated, said salt may decompose, which is conveyed by a release of ions, which will offset the reactions of irreversible consumption of ions notably during the formation of the passivation layer at the surface of the other electrode of opposite sign, during partially irreversible insertion phenomena or reactions at the surface of the electrodes.

Also, the ions required for the formation of the passivation layer do not contribute to the denaturation of the active material of the electrode but the loss in ions for the formation of said layer is offset by the presence of the sacrificial salt. The proportion of ions of the active material of the electrode, for example, positive, therefore are not lost for the formation of said layer during the first charge and therefore the loss of capacity of the accumulator is reduced or even zero. The irreversible reactions of the electrode, for example, negative are offset by an irreversible reaction to the electrode, for example, positive, which is more efficient in terms of density for the accumulator.

The salt present in said layer may be all the salts comprising an anion and an alkali metal counter ion (lithium, for example, when the accumulator is a lithium accumulator; sodium, for example, when the accumulator is a sodium accumulator; potassium, for example, when the accumulator is a potassium accumulator), an alkaline earth metal counter ion (magnesium, for example, when the magnesium accumulator; calcium, for example, when the accumulator is a calcium accumulator), said salts being able to be electrochemically decomposed by releasing the corresponding ion (namely, the aforementioned alkali or alkaline earth ion) and an inert, preferably, gaseous by-product.

By way of example of salts, it may be cited the salts belonging to the following categories:
azides of formula N₃A, with A corresponding to a lithium, sodium or potassium cation; diazides of formula (N₃)₂A¹ with A¹ corresponding to a magnesium or calcium cation;
oxocarbon salts, such as same corresponding to one of the following formulae (I) to (IV):

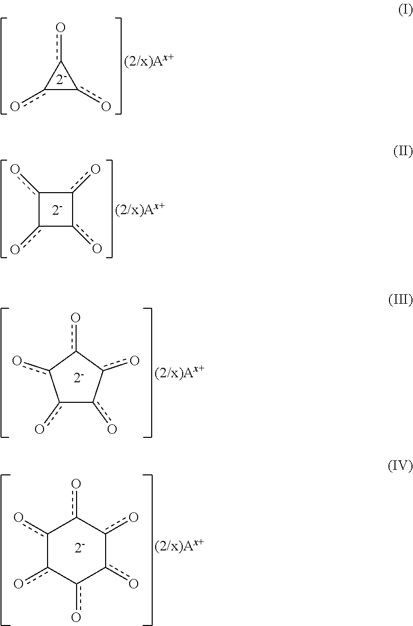

the aforementioned formulae indicating that two negative charges are carried by two oxygen atoms of the cycle to which same are linked, the other oxygen atoms being linked by a double bond to the cycle, A corresponding to a lithium, sodium, potassium, calcium, magnesium cation and x corresponding to the number of charges of the cation;
ketocarboxylates, such as same corresponding to one of the following formulae (V) to (VII):

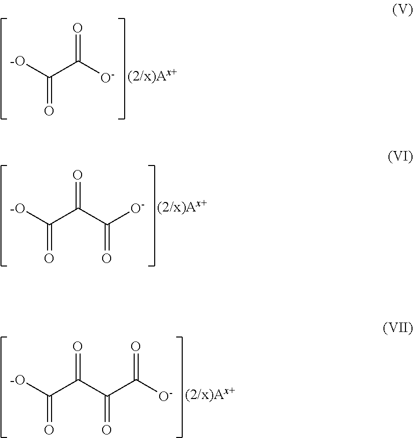

with A corresponding to a lithium, sodium, potassium, calcium, magnesium cation and x corresponding to the number of charges of the cation;
lithium hydrazides, such as same corresponding to one of the following formulae (VIII) and (IX):

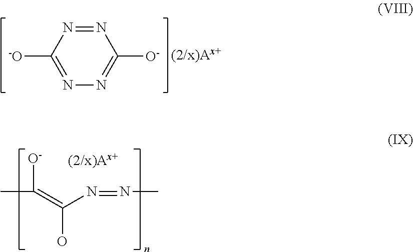

with A corresponding to a lithium, sodium, potassium, calcium, magnesium cation, x corresponding to the number of charges of the cation and n corresponding to the repetition number of the pattern taken between square brackets, said number able to range from 3 to 1,000.

Preferably, the salt or salts included in the inactive layer may be selected from the azides of formula N₃A, with A being such as defined above, the oxocarbon salts of formula (II) such as defined above and the ketocarboxylates of formula (V) such as defined above.

More specifically, when this concerns lithium salts for a lithium accumulator, it may be mentioned as examples:
lithium azide of formula LiN₃;
lithium squarate of following formula (X):

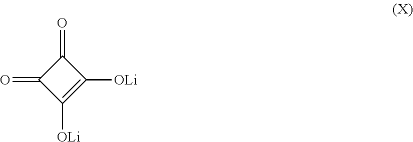

lithium oxalate of following formula (XI):

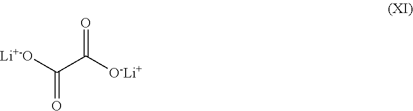

Furthermore, the organic binder or binders may be polymeric binders, which may be selected from vinyl polymers, such as polyvinylidene fluorides (known under the abbreviation PVDF), modified celluloses, such as carboxymethyl celluloses (known under the abbreviation CMC) optionally in the form of salts (for example, sodium carboxymethyl celluloses, ammonium carboxymethyl celluloses), polyacrylates, such as lithium polyacrylates, polyamides, polyimides, polyesters and the mixtures thereof.

Finally, the inactive layer may comprise at least one electronically conductive carbon material.

The electronically conductive carbon material may be a material comprising carbon at the elementary state and, preferably, in divided form, such as spherical particles, blocks or fibres.

It may be cited, as carbon material, graphite; mesocarbon beads; carbon fibres; carbon black, such as acetylene black, channel black, furnace black, lamp black, anthracene black, charcoal black, gas black, thermal black; graphene, carbon nanotubes; and mixtures thereof.

The salt or salts may be present in a content ranging from 1 to 80% by mass in relation to the total mass of the ingredients of the inactive layer. The organic binder or binders may be present in a content ranging from 1 to 50% by mass in relation to the total mass of the ingredients of the inactive layer.

Finally, if applicable, the electronically conductive carbon material may be present in a content ranging from 0.1 to 80% by mass in relation to the total mass of the ingredients of the inactive layer.

Advantageously, the layer exclusively consists of at least one salt such as defined above, whereof one of the ions is same that is involved in the process of ion insertion or deinsertion in the active material, of at least one organic binder such as defined above and, optionally, of at least one electronically conductive carbon material such as defined above.

Structurally, the inactive layer may be in the form of a composite material comprising a polymer matrix consisting of said organic binder or binders, wherein are dispersed the salt or salts and, optionally, the electronically conductive carbon material or materials.

By way of example, the layer may consist of a matrix made of PVDF, wherein are dispersed carbon black and lithium squarate, notably when the collector is intended for a lithium accumulator.

As mentioned above, the inactive layer arranged on the collector of the invention is intended for providing the junction between the current collector and the electrode of an accumulator with ion insertion or deinsertion, which means, in other terms, that the current collector thus coated with an inactive layer is intended for being incorporated into an assembly comprising said collector and an electrode, the inactive layer thus being located interposed between the current collector and the electrode.

Also, the invention also relates to an assembly comprising the current collector such as defined above and an electrode, the inactive layer coating the current collector providing junction between the current collector and the electrode comprising an active material, that is, said in other terms, the inactive layer coating the current collector being inserted between the current collector and the electrode.

The features of the current collector and of the inactive layer already described above may be used on behalf of said assembly.

The electrode, for its part, comprises an active material, that is to say a material suitable for intervening in the insertion and deinsertion reactions occurring during the operation of the accumulator.

When the assembly is intended for a lithium accumulator, the active material of the electrode may be a material of the lithiated oxide type comprising at least one transition metal element, of the lithiated phosphate type comprising at least one transition metal element, of the lithiated silicate type comprising at least one transition metal element or of the lithiated borate type comprising at least one transition metal element.

As examples of lithiated oxide compounds comprising at least one transition metal element, it may be cited simple oxides or mixed oxides (that is to say oxides comprising a plurality of distinct transition metal elements) comprising at least one transition metal element, such as oxides comprising nickel, cobalt, manganese and/or aluminium (said oxides able to be mixed oxides).

More specifically, as mixed oxides comprising nickel, cobalt, manganese and/or aluminium, it may be cited the compounds of following formula (XII):

LiM²O₂ (XII)

wherein M² is an element selected from Ni, Co, Mn, Al and the mixtures thereof.

By way of examples of such oxides, it may be cited the lithiated oxides LiCoO₂, LiNiO₂ and the mixed oxides Li(Ni,Co,Mn)O₂ (such as Li(Ni_{1/3}Mn_{1/3}Co_{1/3})O₂ or Li(Ni_{0.6}Mn_{0.2}CO_{0.2})O₂ (also known under the name NMC), Li(Ni,Co,Al)O₂ (such as Li(Ni_{0.8}Co_{0.15}Al_{0.05})O₂ also known under the name NCA) or Li(Ni,Co,Mn,Al)O₂, the oxides so-called rich in lithium Li₁₊ₓ(Ni,Co,Mn)O₂, x being greater than 0.

As examples of lithiated phosphate compounds comprising at least one transition metal element, it may be cited the compounds of formula LiM¹PO₄, wherein M¹ is selected from Fe, Mn, Ni, Co and the mixtures thereof, such as LiFePO₄.

As examples of lithiated silicate compounds comprising at least one transition metal element, it may be cited the compounds of formula Li₂M¹SiO₄, wherein M¹ is selected from Fe, Mn, Co and the mixtures thereof.

As examples of lithiated borate compounds comprising at least one transition metal element, it may be cited the compounds of formula LiM¹BO₃, wherein M¹ is selected from Fe, Mn, Co and the mixtures thereof.

When the assembly is intended for an accumulator of the sodium-ion type, the active material of the electrode may be:
a material of the sodium oxide type comprising at least one transition metal element;
a material of the sodium sulphate or phosphate type comprising at least one transition metal element;
a material of the sodium fluoride type; or
a material of the sulphate type comprising at least one transition metal element.

As examples of sodium oxide compounds comprising at least one transition metal element, it may be cited simple oxides or mixed oxides (that is to say oxides comprising a plurality of distinct transition metal elements) comprising at least one transition metal element, such as oxides comprising nickel, cobalt, manganese, chromium, titanium, iron and/or aluminium (said oxides able to be mixed oxides).

More specifically, as mixed oxides comprising nickel, cobalt, manganese and/or aluminium, it may be cited the compounds of following formula (XIII):

NaM²O₂ (XIII)

wherein M² is an element selected from Ni, Co, Mn, Al and the mixtures thereof.

By way of example of such oxides, it may be cited the sodium oxides NaCoO₂, NaNiO₂ and the mixed oxides Na(Ni,Co,Mn)O₂ (such as Na(Ni_{1/3}Mn_{1/3}Co_{1/3})O₂), Na(Ni,Co,Al)O₂ (such as Na(Ni_{0.8}Co_{0.15}Al_{0.05})O₂) or Na(Ni,Co,Mn,Al)O₂.

As examples of sodium phosphate compounds comprising at least one transition metal element, it may be cited the compounds of formula NaM¹PO₄, Na₃M¹₂(PO₄)₃, Na₄M¹₃(PO₄)₂P₂O₂, where M¹ is selected from Fe, Mn, Ni, Ti, V, Mo, Co and the mixtures thereof, such as NaFePO₄.

The sodium-based material may be, also, selected from:
sodium fluorophosphates, such as:
fluorophosphates of formula Na₂XPO₄F, wherein X is an element selected from Fe, Mn, Ni, Ti, V, Mo, Co and the mixtures thereof;
fluorophosphates of formula Na₃X₂(PO₄)₂F₃, wherein X is an element selected from Fe, Mn, Ni, Ti, V, Mo Co and the mixtures thereof (said compounds also being designated by the abbreviation NVPF, when X corresponds to vanadium);
sodium fluorosulphates of formula NaT′SO₄F, wherein T′ is an element selected from Fe, Mn, Co, Ni and the mixtures thereof.

As examples of sodium fluoride compounds, it may be cited NaFeF₃, NaMnF₃ and NaNiF₃.

Finally, as examples of sulphate compounds, it may be cited Ni₃S₂, FeS₂ and TiS₂.

When the assembly is intended for an accumulator of the magnesium-ion type, an active material of the electrode may be MoS₆.

When the accumulator is a potassium-ion accumulator, the active materials of the electrode may be materials similar to same of the aforementioned lithium-ion accumulators, if only Li is replaced by K.

Furthermore, the electrode may also comprise at least one organic binder such as a polymeric binder, as polyvinylidene fluoride (PVDF), a carboxymethyl cellulose mixture with a latex of the styrene and/or acrylic type as well as at least one electrically conductive additive, which may be carbon materials, as carbon black. What is more, the positive electrode may be, from a structural point of view, as a composite material comprising a matrix made of organic binder(s) within which are dispersed charges constituted by the active material (being, for example, in particulate form) and optionally the electrically conductive additive or additives. In this case, due to the presence of an intermediate inactive layer between the collector and the electrode, which comprises an electronically conductive carbon material, the quantity in electrically conductive additive(s) present in the electrode may be lower in relation to the embodiments of the prior art, where said intermediate layer is not present. It is the same for the quantity in organic binder(s), when the intermediate layer and the electrode comprise said type of ingredients.

The assembly according to the invention may be produced by simple techniques within the reach of the person skilled in the art and more specifically, by a method comprising the succession of following steps:
a step of forming the inactive layer by deposition, for example, by coating, then drying on a current collector of a first composition comprising at least one organic binder, at least one salt, whereof one of the ions is same that is involved in the process of ion insertion or deinsertion in the active material of the electrode, and optionally at least one electronically conductive carbon material;
a step of forming on the layer thus obtained the electrode by deposition, for example, by coating, then drying of a second composition comprising at least one active material and optionally at least one organic binder and at least one electrically conductive additive.

The deposition speed of the electrode may be increased in relation to same of the inactive layer, due to the fact that the possible quantity of electronically conductive additive(s), of organic binder(s) may be reduced due to the presence of such ingredients in the inactive layer deposited on the collector.

The nature of the electronically conductive carbon material, of the salt, of the active material, of the organic binders and of the electrically conductive additive may be identical to same mentioned in the descriptive part of the assembly as such.

The electrode of the assembly may notably be a positive electrode.

The assembly according to the invention is intended for entering in the constitution of an accumulator.

Thus, the invention also relates to an accumulator comprising at least one assembly such as defined above.

Conventionally, the accumulator of the invention comprises at least one electrochemical cell comprising:
an assembly such as defined above;
an electrode of opposite polarity to the electrode of the assembly; and
an electrolyte arranged between said assembly via the electrode layer and said electrode of opposite polarity.

More specifically, the electrode of the assembly is a positive electrode and the electrode of opposite polarity is therefore a negative electrode.

It is specified that positive electrode means, conventionally, in the foregoing and in the following, the electrode that acts as a cathode, when the generator delivers current (that is to say when same is in the process of discharging) and that acts as an anode when the generator is in the process of charging.

It is specified that negative electrode means, conventionally, in the foregoing and in the following, the electrode that acts as an anode, when the generator delivers current (that is to say when same is in the process of discharging) and that acts as a cathode when the generator is in the process of charging.

Conventionally, the negative electrode comprises, as electrode active material, a material suitable for inserting, reversibly, lithium or for forming an alloy with lithium (when the accumulator is a lithium accumulator), sodium (when the accumulator is a sodium accumulator), potassium (when the accumulator is a potassium accumulator) or magnesium (when the accumulator is a magnesium accumulator).

In particular, for a lithium accumulator, the negative electrode active material may be:
a carbon material, such as hard carbon, natural graphite or artificial graphite;
lithium metal or a material suitable for forming an alloy with lithium, such as silicon, tin; or
a lithium mixed oxide, such as Li₄Ti₅O₁₂ or LiTiO₂.

Furthermore, in the same way as for the positive electrode, notably when same is not made of lithium metal, the negative electrode may comprise an organic binder, such as a polymeric binder, such as polyvinylidene fluoride (PVDF), a carboxymethyl cellulose mixture with a latex of the styrene and/or acrylic type as well as one or more electrically conductive additive, which may be carbon materials, as carbon black. What is more, in the same way as for the positive electrode, the negative electrode may be, from a structural point of view, as a composite material comprising a matrix made of organic binder(s) within which are dispersed charges constituted by the active material (being, for example, in particulate form) and optionally the electrically conductive additive or additives, said composite material able to be deposited on a current collector.

The electrolyte, arranged between the positive electrode and the negative electrode, is for its part a conductive electrolyte of lithium ions (when the accumulator is a lithium accumulator), of sodium ions (when the accumulator is a sodium accumulator), of potassium ions (when the accumulator is a potassium accumulator), of magnesium ions (when the accumulator is a magnesium accumulator), of calcium ions (when the accumulator is a calcium accumulator).

In particular, when the accumulator is a lithium-ion accumulator, the electrolyte may be:
a liquid electrolyte comprising a lithium salt dissolved in at least one organic solvent, such as an aprotic apolar solvent;
an ionic liquid; or
a solid polymer or ceramic electrolyte.

By way of examples of lithium salt, it may be cited LiClO₄, LiAsF₆, LiPF₆, LiBF₄, LiRfSO₃, LiCH₃SO₃, LiN(RfSO₂)₂, Rf being selected from F or a perfluoroalkyl group including from 1 to 8 carbon atoms, lithium trifluoromethanesulfonylimide (known under the abbreviation LiTFSI), lithium bis(oxalato)borate (known under the abbreviation LiBOB), lithium bis(perfluorethylsulfonyl)imide (also known under the abbreviation LiBETI), lithium fluoroalkylphosphate (known under the abbreviation LiFAP).

By way of examples of organic solvents likely to enter in the constitution of the aforementioned electrolyte, it may be cited carbonate solvents, such as cyclic carbonate solvents, linear carbonate solvents and the mixtures thereof.

By way of examples of cyclic carbonate solvents, it may be cited ethylene carbonate (symbolised by the abbreviation EC), propylene carbonate (symbolised by the abbreviation PC).

By way of examples of linear carbonate solvents, it may be cited dimethyl carbonate or diethyl carbonate (symbolised by the abbreviation DEC), dimethyl carbonate (symbolised by the abbreviation DMC), ethylmethyl carbonate (symbolised by the abbreviation EMC).

Furthermore, the electrolyte may be brought to soak a separator element, by a porous polymeric separator element, arranged between the two electrodes of the accumulator.

Other features and advantages of the invention will become apparent from the additional description that follows and that relates to specific embodiments.

Of course, this additional description is given by way of illustration of the invention and in no way constitutes a limitation.

### BRIEF DESCRIPTION OF THE DRAWINGS

The single FIGURE is a graph illustrating the evolution of the potential E (in V vs Li⁺/Li) depending on the specific capacity C (in mAh/g) with the curves a and b referring, respectively, to the first cycle and to the second cycle of the button cell obtained in the example below.

### DETAILED DESCRIPTION OF SPECIFIC EMBODIMENTS

### Example

The present example illustrates the preparation of an assembly according to the invention and the incorporation thereof into a lithium accumulator.

Firstly, it is prepared a sacrificial salt powder, which is lithium squarate, of following formula (X):

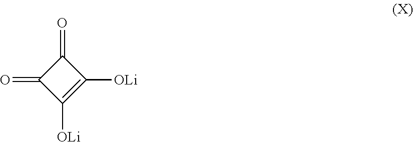

More specifically, lithium squarate is prepared by reaction in stoichiometric quantity of squaric acid with lithium carbonate in aqueous medium. The reactional medium is subsequently evaporated using the rotary evaporator, thereby resulting in a white powder with a quantitative yield. Before use, said powder is dried to 50° C., in order to ensure the elimination of all traces of water.

Secondly, the preparation of a first composition is carried out from the lithium squarate powder obtained. To do this, the lithium squarate powder obtained (45% by dry mass) weighed in a fume cupboard is dispersed in N-methylpyrrolidone in presence of a mixture comprising a PVDF binder (25% by dry mass) and carbon black (Ketjen Black EC600J, 30% by dry mass).

The first composition is coated with a wet thickness of 100 μm on an aluminium strip of 20 μm thickness then dried for 12 hours at 55° C.

At the same time, the preparation of a second composition is carried out comprising LiFePO₄ (70% by mass), carbon black (Super P®, 15% by mass) and PVDF (15% by mass) dispersed in N-methylpyrrolidone (the dry extract being 40% by mass).

Said second composition is subsequently coated with a wet thickness of 100 μm on the layer previously obtained then dried for 12 hours at 55° C.

The assembly thus obtained is subsequently cut in the shape of a disc of 14 mm of diameter and pressed with 10 tonnes, in view of being mounted in a lithium accumulator cell.

The disc thus pressed is subsequently mounted in an accumulator cell being in the form of a button cell with a negative electrode being in the form of a lithium disc of 16 mm of diameter and a polyolefin separator arranged between the negative electrode and the positive electrode, said separator being impregnated with alkyl carbonate-based electrolyte and with a lithium salt.

The button cell thus obtained is subjected to the following test:
during a first cycle at a rate of C/20 between 2.5 V and 4.5 V at 25° C.;
during a second cycle at a rate of C/10 between 2.5 V and 4.5 V at 25° C.

The results of said test are reported in the single FIGURE, which illustrates the evolution of the potential E (in V) depending on the specific capacity C (in mAh/g) of the positive electrode, with the curve a) corresponding to the first cycle and the curve b) corresponding to the second cycle.

During the first charge, it is observed a first plateau at 3.5 V corresponding to the delithiation of the active material LiFePO₄ then a second plateau towards 4 V linked to the electrochemical decomposition of the sacrificial salt contained in the inactive layer deposited on the current collector. Said second phenomenon is no longer visible neither during the discharge, where the lithiation of the LiFePO₄ is observed nor during the second cycle, while the performances of the material of the electrode are retained.

What is claimed is:

1.-19. (canceled)

20. Current collector for an accumulator with ion insertion or deinsertion, said collector is coated on at least one of the faces thereof with an inactive layer intended for providing the junction between said current collector and an electrode comprising an active material, said inactive layer comprising at least one organic binder and at least one salt, whereof one of the ions is same that is involved in the process of ion insertion or deinsertion in the active material of the electrode, said salt being a sacrificial salt.

21. Current collector according to claim 20, which includes a metal substrate.

22. Current collector according to claim 21, wherein the metal substrate consists of one or more metal elements selected from copper, aluminium, nickel and the mixtures thereof.

23. Current collector according to claim 20, wherein the salt is a salt comprising an anion and an alkali metal counter ion selected from lithium, when the accumulator is a lithium accumulator; sodium, when the accumulator is a sodium accumulator; potassium, when the accumulator is a potassium accumulator; an alkaline earth metal counter ion, which is magnesium, when the accumulator is a magnesium accumulator or calcium, when the accumulator is a calcium accumulator.

24. Current collector according to claim 20, wherein the salt is selected from:
azides of formula N₃A, with A corresponding to a lithium, sodium or potassium cation; diazides of formula (N₃)₂A¹ with A¹ corresponding to a magnesium or calcium cation;
oxocarbon salts corresponding to one of the following formulae (I) to (IV): 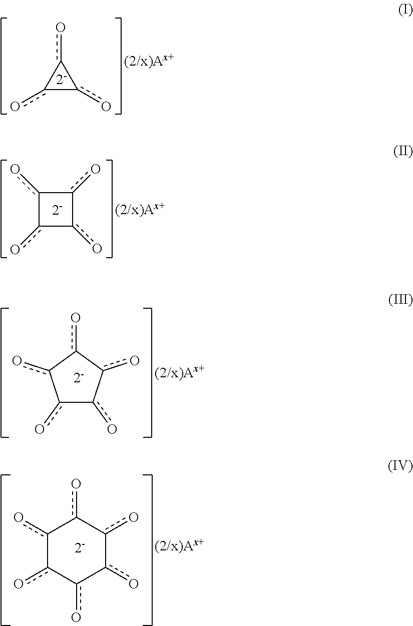
the aforementioned formulae indicating that two negative charges are carried by two oxygen atoms of the cycle to which same are linked, the other oxygen atoms being linked by a double bond to the cycle, A corresponding to a lithium, sodium, potassium, calcium, magnesium cation and x corresponding to the number of charges of the cation;
ketocarboxylates corresponding to one of the following formulae (V) to (VII): 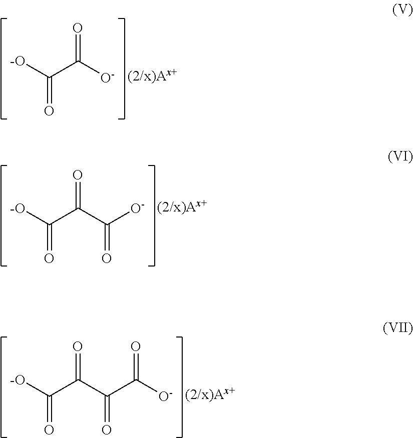
with A corresponding to a lithium, sodium, potassium, calcium, magnesium cation and x corresponding to the number of charges of the cation;
lithium hydrazides corresponding to one of the following formulae (VIII) and (IX): 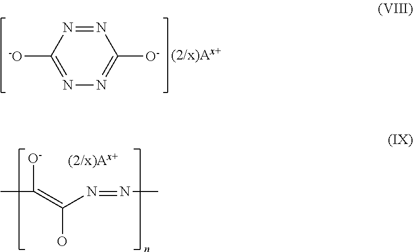
with A corresponding to a lithium, sodium, potassium, calcium, magnesium cation, x corresponding to the number of charges of the cation and n corresponding to the repetition number of the pattern taken between square brackets, said number able to range from 3 to 1000.

25. Current collector according to claim 20, wherein the current collector is intended for a lithium accumulator and the salt is a lithium salt selected from:
lithium azide of formula LiN₃;
lithium squarate of following formula (X): 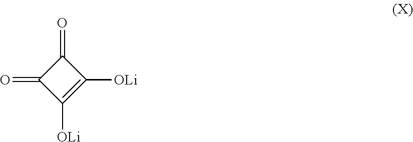
lithium oxalate of following formula (XI):

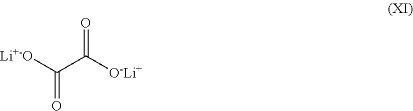

26. Current collector according to claim 20, wherein the organic binder of the inactive layer is a polymeric binder selected from vinyl polymers, such as polyvinylidene fluorides, modified celluloses, such as carboxymethyl celluloses optionally in the form of salts (for example, sodium carboxymethyl celluloses, ammonium carboxymethyl celluloses), polyacrylates, such as lithium polyacrylates, polyamides, polyimides, polyesters and the mixtures thereof.

27. Current collector according to claim 20, wherein the inactive layer further comprises at least one electronically conductive carbon material.

28. Current collector according to claim 27, wherein the electronically conductive carbon material is a material comprising carbon in the elementary state in divided form.

29. Current collector according to claim 27, wherein the electronically conductive carbon material is selected from graphite; mesocarbon beads; carbon fibres; carbon black; graphene; carbon nanotubes and mixtures thereof.

30. Current collector according to claim 20, wherein the inactive layer exclusively consists of said at least one salt, of at least one organic binder as defined in claim 7 and optionally of at least one electronically conductive carbon material as defined in any one of claims 8 to 10.

31. Current collector according to claim 20, wherein the current collector is intended for a lithium accumulator and the inactive layer consists of a matrix made of polyvinylidene fluoride, wherein are dispersed carbon black and lithium squarate.

32. Current collector according to claim 20, wherein the inactive layer is devoid of active material.

33. Assembly comprising the current collector as defined according to claim 20 and an electrode comprising an active material, the inactive layer coating the current collector providing junction between the current collector and the electrode comprising an active material.

34. Assembly according to claim 33, wherein the assembly is intended for a lithium accumulator and the active material is a material of the lithiated oxide type comprising at least one transition metal element, of the lithiated phosphate type comprising at least one transition metal element, of the lithiated silicate type comprising at least one transition metal element or of the lithiated borate type comprising at least one transition metal element.

35. Assembly according to claim 33, wherein the electrode comprises at least one organic binder and at least one electrically conductive additive.

36. Assembly according to claim 33, wherein the electrode is a positive electrode.

37. Accumulator comprising at least one electrochemical cell comprising:
an assembly as defined according to claim 14;
an electrode of opposite polarity to the electrode of the assembly; and
an electrolyte arranged between said assembly via the electrode layer and said electrode of opposite polarity.

38. Accumulator according to claim 37, wherein the electrode of the assembly is a positive electrode and the electrode of opposite polarity is a negative electrode.
